(19) United States
(12) Patent Application Publication
(10) Pub. No.: US 2010/0165921 A1
(43) Pub. Date: Jul. 1, 2010

(54) Mobile Station Handover in a Localized Base Station Environment

(75) Inventors: Shashikant Maheshwari, Irving, TX (US); Tejas Bhatt, Mountain View, CA (US); Yousuf Saifullah, Richardson, TX (US); Haihong Zheng, Coppell, TX (US)

Correspondence Address: BRAKE HUGHES BELLERMANN LLP, c/o CPA Global, P.O. BOX 52050, MINNEAPOLIS, MN, 55402, US

(73) Assignee: Nokia Siemens Networks Oy, Espoo (FI)

(21) Appl. No.: 12/494,630

(22) Filed: Jun. 30, 2009

Related U.S. Application Data
(60) Provisional application No. 61/078,269, filed on Jul. 3, 2008.

(51) Int. Cl. H04W 4/00

(52) U.S. Cl. 370/328

(57) ABSTRACT

According to one general aspect, a method of operating a indoor cellular access point (ICAP) may comprise constructing a neighbor list of neighboring indoor cellular access points (NICAPs). The method may also include detecting at least one overlay macro base stations (OMBSs). In one embodiment, the method may further comprise associating the overlay macro base stations with the indoor cellular access point. The method may also include transmitting a message to a mobile station (MS) wherein the message includes the neighbor list.

### CROSS-REFERENCE TO RELATED APPLICATION

This application claims priority under 35 U.S.C. §119 to U.S. Provisional Patent Application 61/078,269, filed Jul. 3, 2008, titled “MOBILE STATION HANDOVER IN A LOCALIZED BASE STATION ENVIRONMENT,” which is incorporated herein by reference in its entirety.

### TECHNICAL FIELD

This description relates to mobile communication technology, and more specifically to the improvement of mobile station handover in a localized base station environment.

### BACKGROUND

Typically, wireless networks include a base station that generally couples a wired network with a wireless network and mobile station that uses the wireless network. Often these two devices are in direct communication. However, multiple wireless network standards are in use or development. Due to the ranged nature of wireless networks, it is possible that a mobile station may be connected to or in the range of a number of wireless networks.

Worldwide Interoperability for Microwave Access (WiMAX) is a telecommunications technology often aimed at providing wireless data over long distances (e.g., kilometers) in a variety of ways, from point-to-point links to full mobile cellular type access. A network based upon WiMAX is occasionally also called a Wireless Metropolitan Access Network (WirelessMAN or WMAN); although, it is understood that WMANs may include protocols other than WiMAX. WiMAX often includes a network that is substantially in compliance with the IEEE 802.16 standards, their derivatives, or predecessors (hereafter, “the 802.16 standard”). Institute of Electrical and Electronics Engineers, IEEE Standard for Local and Metropolitan Area Networks, Part 16, IEEE Std. 802.16-2004.

In telecommunications, an indoor cellular access point (ICAP) (a.k.a. a femtocell, femto access point (AP), femto base station (BS), home node B (HNB), pico BS, AP BS, etc.) is generally a small cellular base station, that is typically designed for use in residential or small business environments. It often connects to the service provider's network via broadband (e.g., DSL, cable, T1 line, fiber, etc.). An ICAP typically allows service providers or customers to extend service coverage indoors, especially where access would otherwise be limited or unavailable. Although it is understood that the ICAP may be used outdoors, ICAPs are usually placed indoors due in part to the attenuation caused by walls and other structures. Often an ICAP incorporates the functionality (in whole or part) of a typical base station but extends it to allow a simpler, self contained deployment. For example, a business may choose to install one or more ICAPs through-out their building to provide better service to their employees. Although currently much attention is focused on third generation (3G) cellular technology, the concept is applicable to all standards, including WiMAX solutions.

### SUMMARY

According to one general aspect, a method of operating a indoor cellular access point (ICAP) may comprise constructing a neighbor list of neighboring indoor cellular access points (NICAPs). The method may also include detecting at least one overlay macro base stations (OMBSs). In one embodiment, the method may further comprise associating the overlay macro base stations with the indoor cellular access point. The method may also include transmitting a message to a mobile station (MS) wherein the message includes the neighbor list.

According to another general aspect, a method of using a mobile station (MS) with an indoor cellular access point (ICAP) may comprise authorizing the MS to join a network including the ICAP, wherein the network includes a range. In one embodiment, the method may include receiving a message including information regarding a set of neighboring ICAPs (NICAPs). In various embodiments, the method may also comprise updating a neighbor list using at least part of the information of the received message. In some embodiments, the method may include, if the MS leaves the range of the network, updating the neighbor list by removing at least part of the information of the received message. The method may further comprise, if the MS enters the range of the network, updating the neighbor list by adding at least part of the information of the received message.

According to another general aspect, an indoor cellular access point (ICAP) may comprise a wireless transceiver, a controller, and a memory. In various embodiments, the wireless transceiver may be configured to detect at least one overlay macro base stations (OMBSs), and transmit a message to a mobile station (MS) wherein the message includes a neighbor list. In some embodiments, the controller may be configured to construct the neighbor list, wherein the list includes an identification of neighboring indoor cellular access points (NICAPs). In one embodiment, the memory may be configured to associate the OMBSs with the ICAP.

According to another general aspect, a mobile station (MS) capable of interacting with a indoor cellular access point (ICAP) may comprise a wireless transceiver, a controller, and a memory. In various embodiments, the wireless transceiver may be configured to establish the MS on a network including the ICAP, wherein the network includes a range, and receive a message including information regarding a set of neighboring ICAPs (NICAPs). In some embodiments, the wireless transceiver may be configured to detect the ICAP and OMBSs and store the mapping to neighbor list and modify the neighbor list if the MS leaves the range of the network, update the neighbor list by removing the ICAP mapping, and if the MS enters the range of the network, update the neighbor list by adding the ICAP mapping. In some embodiments, the controller may be configured to update a neighbor list using at least part of the information of the received message. In some embodiments, the controller further may be configured to, if the MS leaves the range of the network, update the neighbor list by removing at least part of the information of the received message, and if the MS enters the range of the network, update the neighbor list by adding at least part of the information of the received message. In one embodiment, the memory may be configured to store the neighbor list.

The details of one or more implementations are set forth in the accompanying drawings and the description below. Other features will be apparent from the description and drawings, and from the claims.

A system and/or method for mobile communication, substantially as shown in and/or described in connection with at least one of the figures, as set forth more completely in the claims.

### BRIEF DESCRIPTION OF THE DRAWINGS

FIG. 1 is a block diagram of an example embodiment of a system in accordance with the disclosed subject matter.

FIG. 2 is a block diagram of an example embodiment of a system in accordance with the disclosed subject matter.

FIG. 3 is a block diagram of an example embodiment of two apparatuses in accordance with the disclosed subject matter.

FIG. 4 is a flow chart of an example embodiment of a technique in accordance with the disclosed subject matter.

FIG. 5 is a flow chart of an example embodiment of a technique in accordance with the disclosed subject matter.

### DETAILED DESCRIPTION

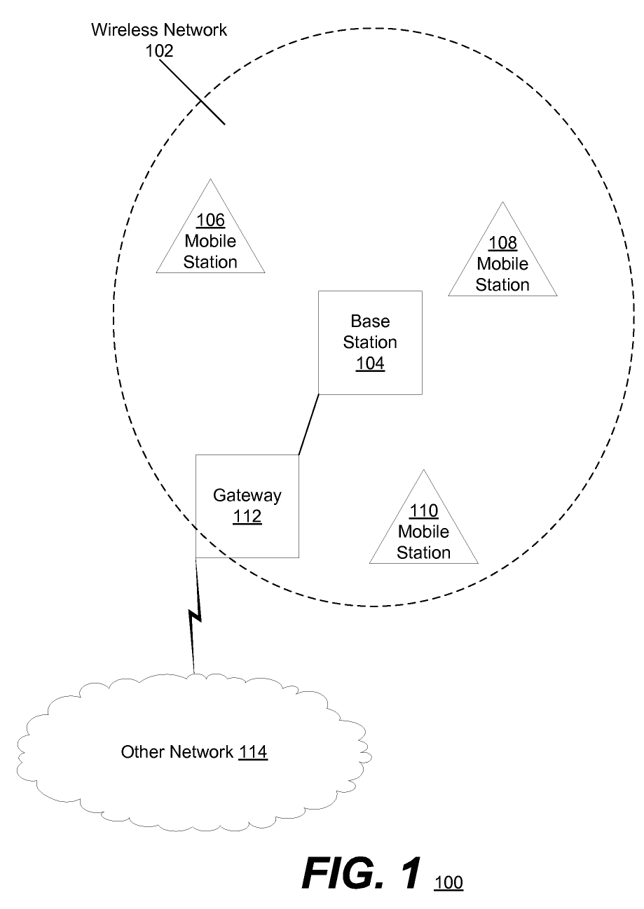

Referring to the Figures in which like numerals indicate like elements, FIG. 1 is a block diagram of a wireless network 102 including a base station (BS) 104 and mobile stations (MSs) 106, 108, 110, according to an example embodiment. Each of the MSs 106, 108, 110 may be associated with BS 104, and may transmit data in an uplink direction to BS 104, and may receive data in a downlink direction from BS 104, for example. Although only one BS 104 and three mobile stations (MSs 106, 108 and 110) are shown, any number of base stations and mobile stations may be provided in network 102. Also, although not shown, mobile stations 106, 108 and 110 may be coupled to base station 104 via relay stations or relay nodes, for example. The base station 104 may be connected via wired or wireless links to another network 114, such as a Local Area Network, a Wide Area Network (WAN), the Internet, etc. In various embodiments, the base station 104 may be coupled or connected with the other network 120 via an access network controller (ASN) or gateway (GW) 112 that may control, monitor, or limit access to the other network.

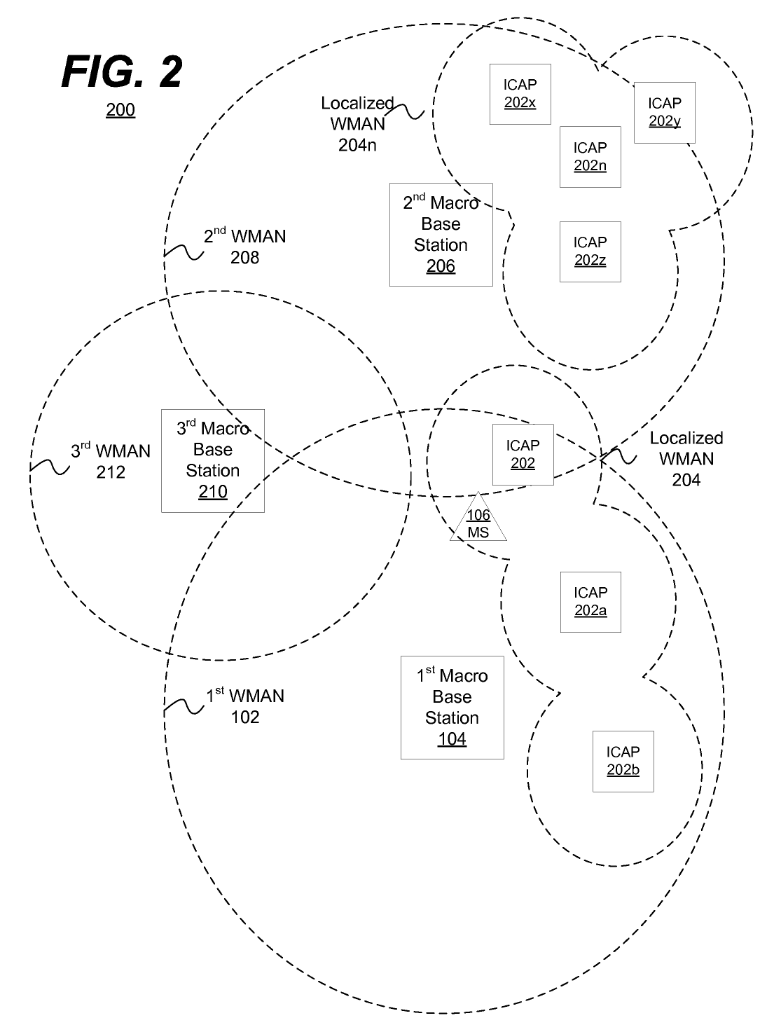

FIG. 2 is a block diagram of an example embodiment of a system 200 in accordance with the disclosed subject matter. In various embodiments, the system may include a BS 104, a MS 106, and a number of ICAPs 202, 202a, and 202b. In various embodiments, the BS 104 may be a macro BS (MBS) that is configured to provide WMAN 102 converge over a range measured in kilometers (e.g., 0.5-50 km, etc.) or decibels per milliwatts (e.g., 45 dBm, etc.). In contrast, in one embodiment, each ICAP 202 may be configured to provide a localized WMAN (e.g., WMAN 204 and 204n) measured in meters (e.g., 500 m, 50 m, 10 m, etc.) or decibels per milliwatts (e.g., 30 dBm, 15 dBm, etc.).

In various embodiments, the MS 106 may make use of the WMAN 102 provided by BS 102 when the MS is outside of the range of the ICAPs 202. As the MS enters the range of the localized WMAN 204 provided by the ICAPs 202, 202a, and 202b, the MS 106 may wish to handover or transfer from the BS 102 to the ICAP 202. In various embodiments, this may provide the MS 106 with better service or a lower cost of communication or reduce signaling load on the WMAN; although, it is understood that the above are merely a few illustrative examples to which the disclosed subject matter is not limited. It is noted that localized WMAN 204 includes the union of the ranges of ICAPs 202, 202a, and 202b, which could have been represented as three separate localized WMANs.

In various embodiments, the ICAP 202 may be installed at a given customer premises. In such an embodiment, the ICAP 202 may be configured. In one embodiment, this configuration may include self-configuration or self-optimization. In various embodiments, the configuration may include setting the system parameters, preamble parameters, power parameters, etc. In various embodiments, the ICAP 202 may be configured with information or parameters relating to the localized WMAN 204, the interaction with ICAPs that provide the other portions of the localized WMAN 204, and the WMAN 102.

In such an embodiment, the ICAP 202 may construct or be provided with a neighbor list that includes a list of neighboring ICAPs that are within the localized WMAN 204. In various embodiments, the ICAP 202 may be provided with an Operator Identifier (OID) that denotes the operator associated with the ICAP 202 and any other ICAPs within the localized WMAN 204 (e.g., ICAP 202a and 202b). In various embodiments, this OID may be issued from a centralized authority.

In various embodiments, the ICAP 202 may be identified by a network ID. The network ID could be, in various embodiments, an OID, Paging Group ID (PGID), or some other network ID that may help the MS to identify the ICAPs within the localized WMAN 204.

For example, in one specific embodiment, the PGID may help the MS to identify ICAPs within a localized WMAN. For example, when the MS is in an idle mode and moves from OMBS coverage to ICAP coverage, it may detect a change in the PGID. In such an embodiment, it may initiate a location update via the ICAP. In this way, the core network knows the MS is located within a localized WMAN 204 coverage. When the network does this paging, it may only need to broadcast the paging message within the localized WMAN 204. PGID may also be used to identify the presence of a localized WMAN, when the MS is in an active mode and is handing over from a OMBS's coverage area to an ICAPs within localized WMAN 204.

For example, in one specific embodiment, the OID may be issued from the IEEE. Therefore, if Company A wishes to operate a localized WMAN, in various embodiments, Company A may have to request an OID from the IEEE. In various embodiments, this OID may be issued automatically or manually. In various embodiments, this OID may be part of base station ID (BSID) provided and configured into the ICAP 202. In such an embodiment, the OID may include the first three bytes of the BSID, as discussed in the 802.16 standard. In such an embodiment, the remaining three bytes of the BSID may be a serial number of the ICAP 202. In such an embodiment, the ICAP may derive or generate its OID from the BSID.

In various embodiments, the ICAP 202 may use the OID as a mask to generate the neighbor list. In such an embodiment, the ICAP 202 may scan for neighboring ICAPs (NICAPs) within the range of the ICAP 202. In various embodiments, each ICAP or BS may periodically broadcast a message (e.g., a downlink or uplink medium access protocol message (DL-MAP, or UL-MAP)) announcing their BSID and other relevant broadcasting parameters (e.g., frequency, physical layer (PHY) ID, etc.). The ICAP 202 may, in one embodiment, receive these broadcast messages and derive the OID of the NICAPs from their BSID. If the OID of the NICAP (e.g., ICAP 202a) is substantially equivalent to the OID of the ICAP 202, the ICAP 202 may determine that the NICAP is within the same network as the ICAP 202 and add the NICAP 202a to the neighbor list.

For example, in one specific embodiment, Company A may occupy the fourth floor of an office building. Company B may occupy the fifth floor of the same office building. Both companies may establish localized WMANs via ICAPs for their employees. Company A may acquire the OID “123” and configure each of their ICAPs to use this OID. Company B may acquire the OID “789” and configure each of their ICAPs to use this OID. An ICAP within the Company A WMAN may scan for NICAPs and find both ICAPs belonging to Company A and to Company B. In such an embodiment, the ICAP may use the OID to selectively place only Company A ICAPs (which include the OID of “123” just as the scanning ICAP) within the neighbor list of the ICAP. Although, it is understood that the above is merely one illustrative example to which the disclosed subject matter is not limited.

In other embodiments, the ICAP 202 may be provided with a list of approved NICAPs from a gateway server (e.g., gateway 112 of FIG. 1, in which in one embodiment ICAP 202 is represented by BS 104). In various embodiments, the list of NICAPs may include a predefined list of ICAP BSIDs. In another embodiment, the list may include a list of acceptable OIDs; for example, a company may have a number of OIDs (e.g., for each subsidiary, campus, etc.). In some embodiments, the provided list may include individual BSIDs, OIDs, BSID masks that may be used to identify multiple ICAPs, or a combination thereof. In various embodiments, the ICAP 202 may receive a message from the gateway that includes the list or information.

In yet another embodiment, the ICAP 202 may scan, as described above, for NICAPs within range of the ICAP 202. In such an embodiment, the ICAP 202 may transmit a message requesting that a gateway or other authorizing device determine if a scanned NICAP is within the same network as the ICAP 202. In various embodiments, the ICAP 202 may receive a message, from the gateway or other authorizing device, indicating whether or not the scanned NICAP is within the same network as the ICAP 202. For example, the ICAP 202 may submit the BSID of ICAP 202a for verification to the gateway. In such an embodiment, the gateway may return a message indicating that ICAP 202a is indeed part of the localized WMAN 204. In such an embodiment, the ICAP 202 may add the approved NICAP (or an identifier of the NICAP, e.g., the NICAP's BSID) to the neighbor list. Conversely, if the NICAP is not approved by the gateway, the ICAP may not, in one embodiment, add the NICAP to the neighbor list.

In one embodiment, the ICAP 202 may construct the neighbor list by using a physical location to determine the NICAPs. In such an embodiment, the ICAP 202 may be aware of its own physical location (e.g., via a GPS receiver, programmed configuration value, etc.). In such an embodiment, the ICAP 202 may limit the NICAPs on the neighbor list by their physical location. In some embodiments, this physical location may be broadcast, as described above. In another embodiment, the physical location may be provided or approved by a gateway server or other authorizing entity. In various embodiments, location may be used alone to determine which NICAPs may be added to the neighbor list. For example, to use the specific example above, the ICAPs of Company A may limit their neighbor list to only ICAPs occupying the fourth floor of the office building. In other embodiments, location may be used to reduce or minimize the neighbor list. For example, if an OID is used by a company at multiple sites, location may be used to reduce the neighbor list to only ICAPs located at the same cite as the ICAP 202. Although, it is understood that the above are merely a few illustrative examples to which the disclosed subject matter is not limited.

In various embodiments, the ICAP 202 may receive one or more messages from a mobile station (MS) 106 regarding the neighbor list. In such an embodiment, the MS 106 may report measurements made regarding NICAPs (e.g., signal strength, BSIDs, etc.) to the ICAP 202. In one embodiment, the ICAP 202 may improve the neighbor list based upon these received messages. In various embodiments, these improvements may include adding or deleting NICAPs from the neighbor list. In some embodiments, the ICAP 202 may report (e.g., via a transmitted message) these improvements or the improved neighbor list to the gateway server.

In various embodiments, the ICAP 202 may also identify or detect at least one overlay macro base station (OMBS) 104. In various embodiments, an overlay marco-BS may include a macro BS whose range overlaps that of the respective ICAP. In various embodiments, the selection of an OMBS may be further limited by the network carrier used by the OMBS and ICAP. For example in one specific embodiment, ICAP 202 may make use of cellular Carrier X and there may be two MBSs that overlap the range of ICAP 202. One MBS may use Carrier Y and the other MBS Carrier X. In such an embodiment, the Carrier X MBS may be detected as the OMBS and the Carrier Y MBS may be rejected. Although, it is understood that the above is merely one illustrative example to which the disclosed subject matter is not limited. In various embodiments, the detected OMBS 104 may be associated with the ICAP 202.

In various embodiments, a mobile station (MS) 106 may attempt to access the localized WMAN 204. In some embodiments, the MS 106 may transfer or handover to the localized WMAN 204 from the WMAN 102, and therefore from the OMBS 102 to the ICAP 202. In another embodiment, the MS 106 may first be turned on within the range of the localized WMAN 204. Although, it is understood that the above are merely a few illustrative examples to which the disclosed subject matter is not limited.

In various embodiments, the MS 106 may perform a network authorization to prove that it or the user of the MS 106 is allowed to have access to the localized WMAN 204. In various embodiments, authorization may take many forms. For example, in one embodiment, authorization may include manually registering and configuring the MS 106 via the MS 106 itself. In such an embodiment, the authorization may include the use of specialized software, etc. In another embodiment, the authorization may include authenticating the MS 106 via a web site, for example. In yet another embodiment, authenticating may include using a preconfigured profile or other credentials certificate (which may, in one embodiment, take the form a file stored by the MS 106). In such an embodiment, the profile may be automatically or manually transmitted to the ICAP 202, gateway server, or other authorizing entity. Although, it is understood that the above are merely a few illustrative examples to which the disclosed subject matter is not limited. In various embodiments, the MS 106 may initiate or respond to the authorization and other devices (e.g., the gateway, etc.) may also take part in the authorization process.

In various embodiments, once the MS 106 is authorized or as part of the authorization, the ICAP 202 may transit a message to the MS 106 that includes the neighbor list. The MS 106 may receive this message and update its neighbor list. In various embodiments, once the MS 106 is authorized or as part of the authorization, the MS 106 may detect and store a mapping of OMBSs and ICAP within localized WMAN 204, as discussed below.

In various embodiments, the neighbor list may be used by the MS 106 to optimize or improve the search for BSs. The MS 106, as a mobile device may periodically, in one embodiment, search for new BSs to connect with. If a better BS is found (e.g., ICAP 202a) a MS 106 may perform a handover from the current BS (e.g., ICAP 202) to the better BS (e.g., ICAP 202a). In various embodiments, the neighbor list may be used to improve this process. It may be used to ignore various BSs that the MS 106 is not authorized to connect with.

In various embodiments, a BS may advertize its neighbor list or set to any associated MSs. This may be done, in one embodiment, to allow the MS to monitor and/or initiate handovers from the current BS to another target BS. In some embodiments, the neighbor list messages may be broadcast over a common radio or transport channel (based, in one embodiment, on the protocol used) that is monitored by any MSs within the range of the BS. In various embodiments, the size of the neighbor list may be limited, for example by a standard. One such embodiment includes the Third Generation Partnership Project (3GPP) cellular standard that limits the number of neighbors on the list to 32.

Returning to the specific embodiment discussed above, Company B on the fifth floor may restrict their localize WMAN to only employees of Company B. An employee of Company A may bring their MS to work. This MS may authenticate and be added to the Company A WMAN. However, periodically the MS may search for better BSs to connect with. Without a restricted neighbor list that includes only Company A ICAPs, the MS may frequently attempt to connect to a “better” Company B ICAP. Because this ICAP does not authorize Company A employees on their network, this connection attempt would likely fail. This may be a waste of the MS's resources (e.g., power, bandwidth, etc.). Although, it is understood that the above is merely one illustrative example to which the disclosed subject matter is not limited.

In various embodiments, the MS 106 may receive a message that includes one or more OIDs, as described above. In such an embodiment, the MS 106 may update its neighbor list with the OID or a mask based upon the OID. In some embodiments, the MS 106 may use the OID as a mask to identify ICAPs belonging within the localized WMAN 204. In various embodiments, the MS 106 may receive a BSID from an ICAP (e.g., ICAP 202a). The MS 106 may derive the OID of the ICAP 202a from the BSID. In one embodiment, if the ICAP's OID is substantially equivalent to the OID received in the neighbor list message, the MS 106 may consider the ICAP 202a as being on the neighbor list. In another embodiment, the MS 106 may add the ICAP 202a to the neighbor list.

In some embodiments, the MS 106 may receive a message that includes a list of BSIDs for a plurality of ICAPs (e.g., ICAPs 202, 202a, and 202b). In such an embodiment, the MS 106 may update its neighbor list by adding the list of BSIDs to the neighbor list. In some embodiments, the neighbor list may already include a number of entries that may or may not be associated with the localized WMAN 204.

In yet another embodiment, the MS 106 may receive more information in the neighbor list message from the ICAP 202 than the MS 106 adds (or deletes) from the MS's 106 neighbor list. For example, the neighbor list message may include both BSIDs and a physical location for each BSID. In such an embodiment, the MS 106 may only add BSIDs to the neighbor list that are physically close to the MS 106; although, it is understood that the above is merely one illustrative example to which the disclosed subject matter is not limited.

In one embodiment, the received neighbor list message or another message transmitted by the ICAP 202 and received by the MS 106 may include a mapping of NICAPs and OMBSs. For example, the message may map the OMBS 104 to ICAPs 202, 202a, and 202b. In various embodiments, only ICAPs on the edge of a localized WMAN may transmit this OMBS as a neighbor in their neighbor list message. For example, in the embodiment illustrated by FIG. 2, all the ICAPs 202, 202a, and 202b are on the one the edge of localized WMAN 204; therefore, any of these ICAPs 202, 202a, and 202b may transmit the OMBS as a neighbor in their neighbor list message.

In another embodiment, also illustrated by FIG. 2, the localized WMAN 204n includes ICAPs 202n, 202x, 202y, and 202z. In such an embodiment, the ICAP 202n is not on the edge of the localized WMAN 204, and may not, in one embodiment, transmit the OMBS as a neighbor in their neighbor list message. In some embodiments, the ICAPs 202x, 202y, and 202z may transmit a OMBS as a neighbor in their neighbor list message that maps ICAPs 202x, 202y, and 202z with OMBS 206, but does not associate ICAP 202n with any OMBS.

In various embodiments, the MS 106, being a mobile device, may leave the range of the localized WMAN 204. In various embodiments, the MS 106 may transfer or handover from the ICAP 202 to the OMBS 104. In such an embodiment, when the MS 106 leaves the range of the OMBS 104, the MS 106 may update its neighbor list by removing at least part of the information included in the received neighbor list message. In various embodiments, the MS 106 may remove the ICAPs 202, 202a, and 202b from the neighbor list. In some embodiments, the MS 106 may store the ICAP information, just not in the neighbor list, or, in one embodiment, in the neighbor list but not in an active state.

In one embodiment, the MS 106 may enter or re-enter the range of the OMBS 104. In such an embodiment, when the MS 106 enters the range of the OMBS 104, the MS 106 may update the neighbor list by adding at least part of the information of the previously received neighbor list message. In some embodiments, the MS 106 may add the ICAPs 202, 202a, and 202b to the neighbor list.

In various embodiments, the MS 106 may maintain an associative list, associative array, or mapping between OMBSs and ICAPs. For example, both localized WMANs 204 and 204n may be part of a larger network that uses a single OID. In such an embodiment, the MS 106 may have received a message from the ICAP 202 or other device that includes a mapping of the OID to a plurality of MBSs. In some embodiments, the MS 106 may maintain an associate list that maps the OMBS 104 to the ICAPs 202, 202a, and 202b, and maps OMBS 206 to ICAPs 202x, 202y, 202z.

In such an embodiment, as the MS 106 travels it may determine if a MBS that is in range of the MS 106 is an OMBS, as described in the associate list. In one embodiment, if the MS 106 comes within range of the MBS 210, the MS 106 may determine that no known or acceptable ICAPs are associated with the MBS 210. In one embodiment, if the MBS 210 is not associated with an ICAP, the MS 106 may remove any NICAPs from the MS's 106 neighbor list. In other embodiments, the MS 106 may simply not add any ICAPs to the neighbor list.

Conversely, in another embodiment, if the MS 106 comes within range of a MBS that is marked or noted in the associate list as an OMBS, the MS 106 may add the associated NICAPs to the neighbor list. For example, in one embodiment, the MS 106 may come within range of the MBS 206. The MS 106 may determine that the ICAPs 202x, 202y, and 202z are associated with the MBS 206. In one embodiment, the MS 106 may update the neighbor list by adding the associated NICAPs to the list. In various embodiments, this process may be automatic. In one embodiment, the MS 106 may then be configured to search for and/or join the localized WMAN 204n when the MS 106 comes within range.

In one embodiment, the MS 106 may store at least one piece of information associated with the ICAP or the OMBS. In various embodiments, the information may include the carrier frequency of the ICAP 202 or OMBS 104, a preamble identifier of the ICAP 202, or a physical location, etc. In various embodiments, the use the information of the afore mentioned BSIDs or OID to reduce the power usage of the MS 106. For example, in one embodiment, MS 106 may reduce power by not searching for ICAPs when the MS is not within the range of a MBS that includes an ICAP. In another embodiment, the MS 106 may reduce power by not responding or only partially processing to any messages received from ICAPs that are not associated with the stores information. In one embodiment, the MS 106 may use the stored information to improve the base station search technique by the MS 106 to find a BS, as described above.

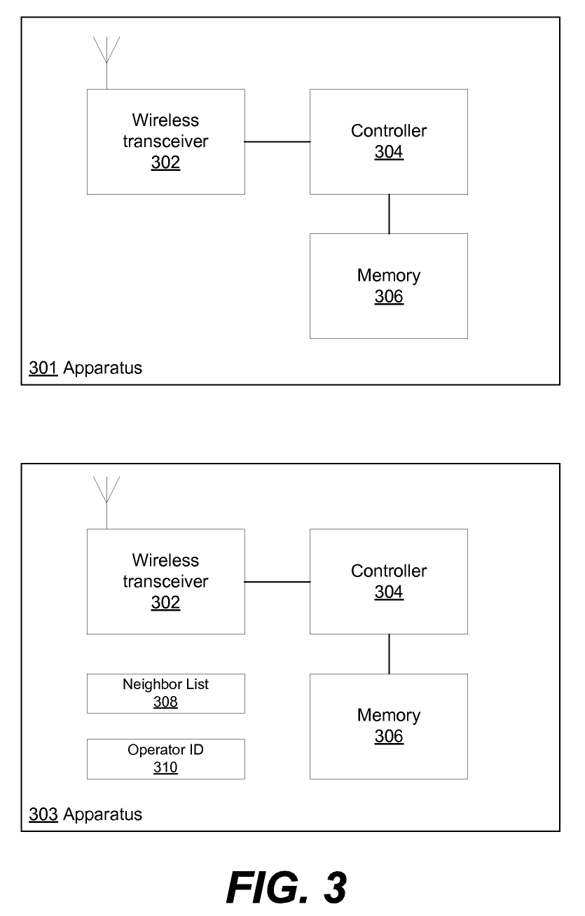

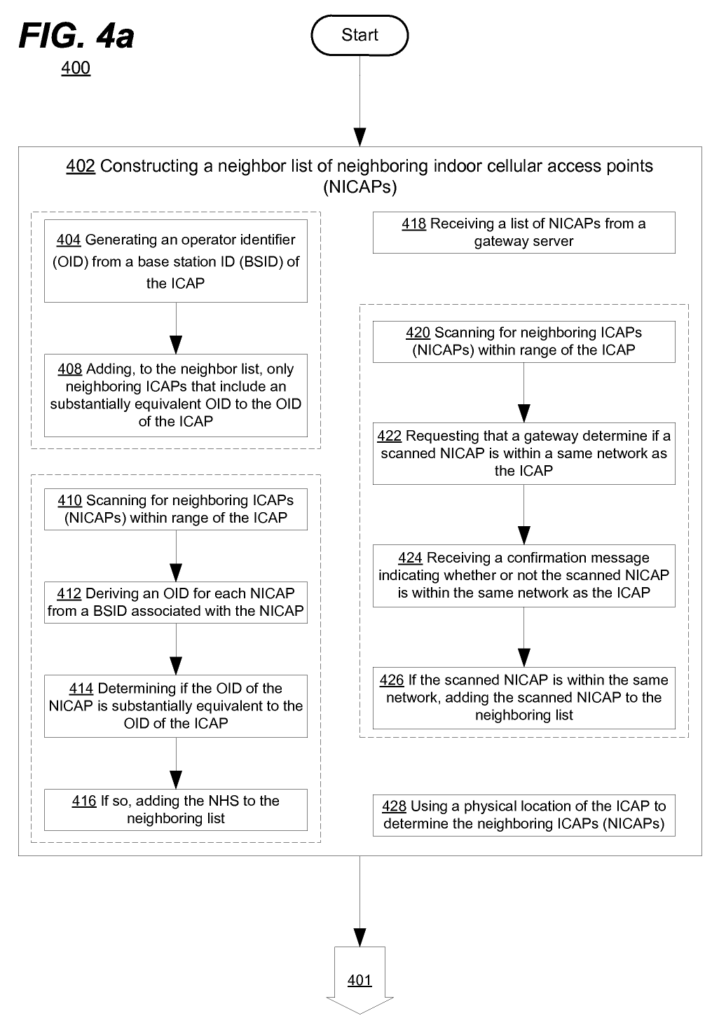

FIG. 3 is also a block diagram of a wireless device 301 in accordance with an example embodiment of the disclosed subject matter. In one embodiment, the wireless device 301 may include an indoor cellular access point (ICAP) or a mobile station (MS) such as that illustrated in FIG. 2. In one embodiment, the wireless device 301 may include a wireless transceiver 302, a controller 304, and a memory 306. In some embodiments, the transceiver 302 may include a wireless transceiver configured to operate based upon a wireless networking standard (e.g., WiMAX, WiFi, WLAN, etc.). In various embodiments, the controller 304 may include a processor. In various embodiments, the memory 306 may include permanent (e.g., compact disc, etc.), semi-permanent (e.g., a hard drive, etc.), or temporary (e.g., volatile random access memory, etc.) memory. For example, some operations illustrated and/or described herein, may be performed by a controller 304, under control of software, firmware, or a combination thereof. In another example, some components illustrated and/or described herein, may be stored in memory 306.

FIG. 3 is also a block diagram of a wireless device 303 in accordance with an example embodiment of the disclosed subject matter. In one embodiment, the wireless device 301 may include an indoor cellular access point (ICAP) or a mobile station (MS) such as that illustrated in FIG. 2. In one embodiment, the wireless device 301 may include a wireless transceiver 302, a controller 304, and a memory 306. In some embodiments, the transceiver 302 may include a wireless transceiver configured to operate based upon a wireless networking standard (e.g., WiMAX, WiFi, WLAN, etc.). In various embodiments, the controller 304 may include a processor. In various embodiments, the wireless device 303 may include a neighbor list 308 configured to facilitate the searching of the wireless device 303 for wireless networks to join, as described above. In one embodiment, the wireless device 303 may include an operator ID (OID) 310 that is configured to identifier the operator of the wireless device 303, as described above. In various embodiments, as described above, the OID 310 may be included as part of a BSID (not shown). In some embodiments, the neighbor list 308 and OID 310 may be stored as part of the memory 306. In one embodiment, the OID 310 or memory 306 may include a network ID or PGID that is configured to identify the operator or network of the wireless device 303, as described above.

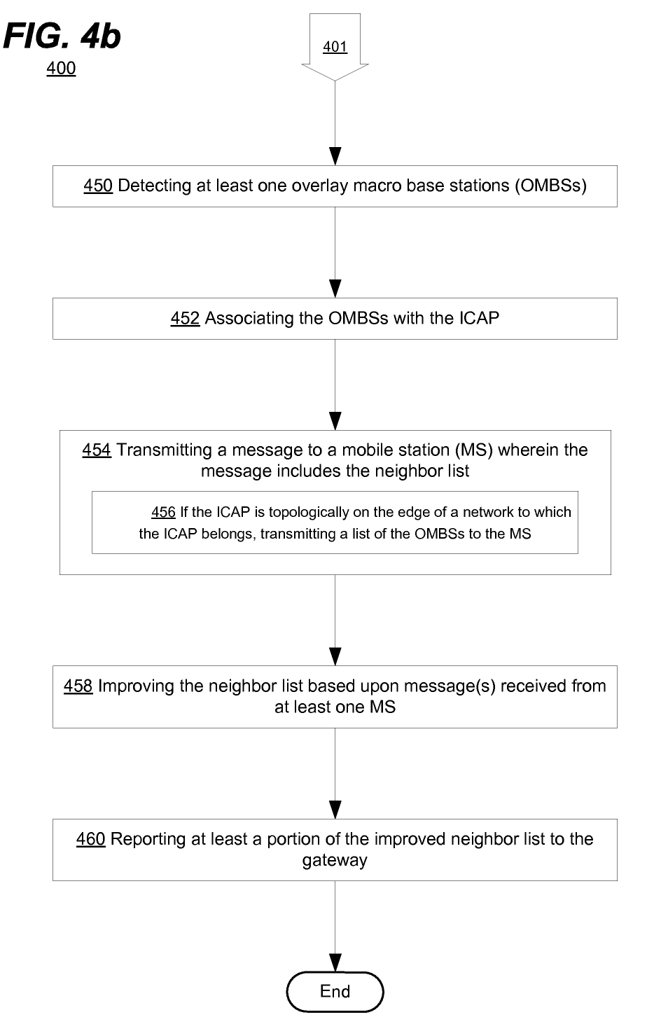

FIG. 4 is a flowchart of an example embodiment of a technique 400 in accordance with the disclosed subject matter. In various embodiments, parts or all of the technique 400 may be the results of the operations of the system 200 of FIG. 2 or system 300 of FIG. 3. Although, it is understood that other systems and timing diagrams may produce technique 400. Furthermore, it is understood that FIGS. 4a and 4b represent a single flowchart illustrated on multiple pages and connected via the connectors of Block 401, here-before and here after the multiple pages will simply be referred to as FIG. 4.

Block 402 illustrates that, in one embodiment, a neighbor list of neighboring indoor cellular access points (NICAPs) may be constructed by an ICAP, as described above. In one embodiment, the ICAP 202 of FIG. 2 or the controller 304 of FIG. 3 may perform this action, as described above.

Block 404 illustrates that, in one embodiment, constructing may include generating an operator identifier (OID) from a base station ID (BSID) of the ICAP, as described above. Block 408 illustrates that, in one embodiment, constructing may include adding, to the neighbor list, only neighboring ICAPs that include an substantially equivalent OID to the OID of the ICAP, as described above. In one embodiment, the ICAP 202 of FIG. 2 or the controller 304 of FIG. 3 may perform this action, as described above.

Block 410 illustrates that, in one embodiment, constructing may include scanning for neighboring ICAPs (NICAPs) within range of the ICAP, as described above. In one embodiment, the ICAP 202 of FIG. 2 or the transceiver 302 of FIG. 3 may perform this action, as described above. Block 412 illustrates that, in one embodiment, constructing may include deriving an OID for each NICAP from a BSID associated with the NICAP, as described above. Block 414 illustrates that, in one embodiment, constructing may include determining if the OID of the NICAP is substantially equivalent to the OID of the ICAP, as described above. Block 416 illustrates that, in one embodiment, constructing may include, if the OIDs are substantially equivalent, adding the NHS to the neighboring list, as described above. In one embodiment, the ICAP 202 of FIG. 2 or the controller 304 of FIG. 3 may perform these actions, as described above.

Block 18 illustrates that, in one embodiment, constructing may include 418 Receiving a list of NICAPs from a gateway server, as described above. In one embodiment, the ICAP 202 of FIG. 2 or the transceiver 302 of FIG. 3 may perform this action, as described above.

Block 420 illustrates that, in one embodiment, constructing may include scanning for neighboring ICAPs (NICAPs) within range of the ICAP, as described above. Block 422 illustrates that, in one embodiment, constructing may include requesting that a gateway determine if a scanned NICAP is within a same network as the ICAP, as described above. Block 424 illustrates that, in one embodiment, constructing may include receiving a confirmation message indicating whether or not the scanned NICAP is within the same network as the ICAP, as described above. In one embodiment, the ICAP 202 of FIG. 2 or the transceiver 302 of FIG. 3 may perform these actions, as described above. Block 426 illustrates that, in one embodiment, constructing may include, if the scanned NICAP is within the same network, adding the scanned NICAP to the neighboring list, as described above. In one embodiment, the ICAP 202 of FIG. 2 or the controller 304 of FIG. 3 may perform this action, as described above.

Block 428 illustrates that, in one embodiment, constructing may include using a physical location of the ICAP to determine the neighboring ICAPs (NICAPs), as described above. In one embodiment, the ICAP 202 of FIG. 2 or the controller 304 of FIG. 3 may perform this action, as described above.

Block 450 illustrates that, in one embodiment, at least one overlay macro base stations (OMBSs) may be detected by the ICAP, as described above. In one embodiment, the ICAP 202 of FIG. 2 or the transceiver 302 of FIG. 3 may perform this action, as described above.

Block 452 illustrates that, in one embodiment, the OMBSs may be associated with the ICAP, as described above. In one embodiment, the ICAP 202 of FIG. 2 or the controller 304 of FIG. 3 may perform this action, as described above.

Block 454 illustrates that, in one embodiment, a message or messages may be transmitted to a mobile station (MS) wherein the message includes the neighbor list, as described above. Block 456 illustrates that, in one embodiment, transmitting may include, if the ICAP is topologically on the edge of a network to which the ICAP belongs, transmitting a list of the OMBSs to the MS, as described above. In one embodiment, the ICAP 202 of FIG. 2 or the transceiver 302 of FIG. 3 may perform these actions, as described above.

Block 458 illustrates that, in one embodiment, the neighbor list may be improved based upon message(s) received from at least one MS, as described above. In one embodiment, the ICAP 202 of FIG. 2 or the controller 304 of FIG. 3 may perform this action, as described above.

Block 460 illustrates that, in one embodiment, at least a portion of the improved neighbor list may be reported to the gateway, as described above. In one embodiment, the ICAP 202 of FIG. 2 or the transceiver 302 of FIG. 3 may perform this action, as described above.

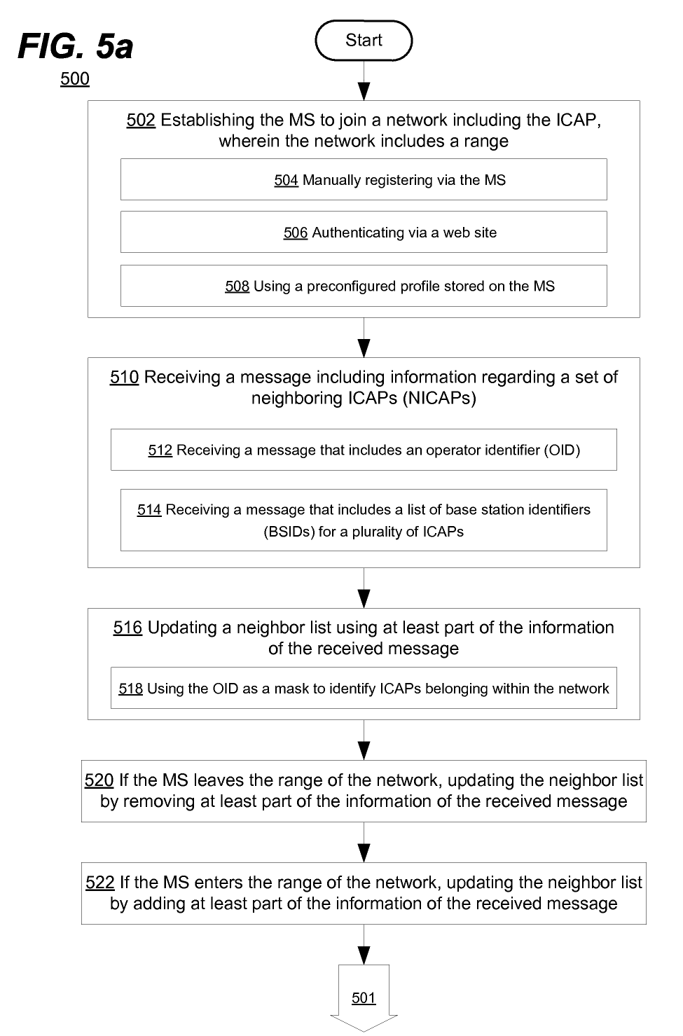

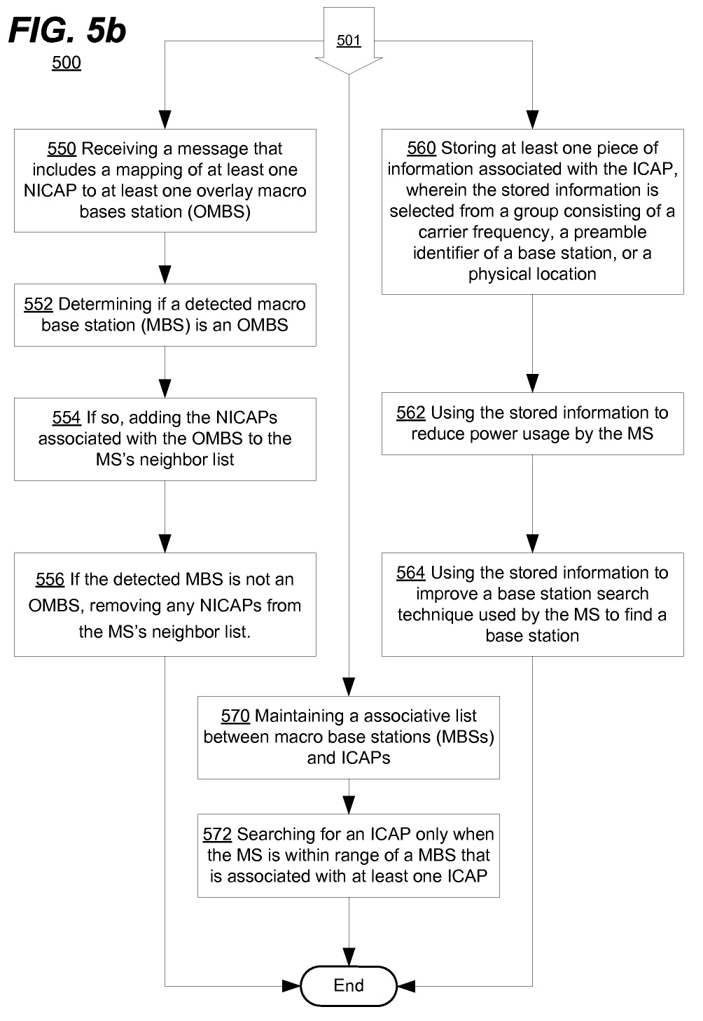

FIG. 5 is a flow chart of an example embodiment of a technique 500 in accordance with the disclosed subject matter. In various embodiments, parts or all of the technique 500 may be the results of the operations of the system 200 of FIG. 2 or system 300 of FIG. 3. Although, it is understood that other systems and timing diagrams may produce technique 500. Furthermore, it is understood that FIGS. 5a and 5b represent a single flowchart illustrated on multiple pages and connected via the connectors of Block 501, here-before and here after the multiple pages will simply be referred to as FIG. 5. While FIG. 5b shows three separate flows in the flow chart it is understood that these actions are not necessarily mutually exclusive and in some embodiments may be combined in whole or part.

Block 503 illustrates that, in one embodiment, the MS may be established to join a network including the ICAP, wherein the network includes a range, as described above. As described above, authorization may, in one embodiment, include only the MS components of a multi-step authorization process. In one embodiment, the MS 106 of FIG. 2 or the transceiver 302 of FIG. 3 may perform this action, as described above.

Block 504 illustrates that, in one embodiment, authorizing or establishing may include manually registering via the MS, as described above. Block 506 illustrates that, in one embodiment, establishing may include authenticating via a web site, as described above. Block 508 illustrates that, in one embodiment, establishing may include using a preconfigured profile stored on the MS, as described above. In one embodiment, the MS 106 of FIG. 2 or the transceiver 302 of FIG. 3 may perform these actions, as described above.

Block 510 illustrates that, in one embodiment, a message including information regarding a set of neighboring ICAPs (NICAPs) may be received, as described above. Block 512 illustrates that, in one embodiment, receiving may include receiving a message that includes an operator identifier (OID), as described above. Block 514 illustrates that, in one embodiment, receiving may include receiving a message that includes a list of base station identifiers (BSIDs) for a plurality of ICAPs, as described above. In one embodiment, the MS 106 of FIG. 2 or the transceiver 302 of FIG. 3 may perform these actions, as described above.

Block 516 illustrates that, in one embodiment, a neighbor list may be updated using at least part of the information of the received message, as described above. Block 518 illustrates that, in one embodiment, updating may include using the OID as a mask to identify ICAPs belonging within the network, as described above. In one embodiment, the MS 106 of FIG. 2 or the controller 304 of FIG. 3 may perform these actions, as described above.

Block 520 illustrates that, in one embodiment, if the MS leaves the range of the network, the neighbor list may be updated by removing at least part of the information of the received message, as described above. Block 522 illustrates that, in one embodiment, if the MS enters the range of the network, the neighbor list may be updated by adding at least part of the information of the received message, as described above. In one embodiment, the MS 106 of FIG. 2 or the controller 304 of FIG. 3 may perform these actions, as described above.

Block 550 illustrates that, in one embodiment, a message may be received that includes a mapping of at least one NICAP to at least one overlay macro bases station (OMBS), as described above. In one embodiment, the MS 106 of FIG. 2 or the transceiver 302 of FIG. 3 may perform this action, as described above. Block 552 illustrates that, in one embodiment, a determination may be made as to whether a detected macro base station (MBS) is an OMBS, as described above. Block 554 illustrates that, in one embodiment, if the MBS is an OMBS, the NICAPs associated with the OMBS may be added to the MS's neighbor list, as described above. Block 556 illustrates that, in one embodiment, if the detected MBS is not an OMBS, any NICAPs may be removed from the MS's neighbor list, as described above. In one embodiment, the MS 106 of FIG. 2 or the controller 304 of FIG. 3 may perform these actions, as described above.

Block 560 illustrates that, in one embodiment, at least one piece of information associated with the ICAP may be stored. In various embodiments, the stored information may include at least one of the following: a carrier frequency, a preamble identifier of a base station, or a physical location, as described above. In one embodiment, the MS 106 of FIG. 2 or the memory 306 of FIG. 3 may perform this action, as described above. Block 562 illustrates that, in one embodiment, the stored information may be used to reduce power usage by the MS, as described above. Block 564 illustrates that, in one embodiment, the stored information may be used to improve a base station search technique used by the MS to find a base station, as described above. In one embodiment, the MS 106 of FIG. 2 or the controller 304 of FIG. 3 may perform these actions, as described above.

Block 570 illustrates that, in one embodiment, a associative list between macro base stations (MBSs) and ICAPs may be maintained, as described above. In one embodiment, the MS 106 of FIG. 2 or the memory 306 of FIG. 3 may perform this action, as described above. Block 572 illustrates that, in one embodiment, a search may be made for an ICAP only when the MS is within range of a MBS that is associated with at least one ICAP. In one embodiment, the MS 106 of FIG. 2 or the transceiver 302 of FIG. 3 may perform this action, as described above.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A method of operating a indoor cellular access point (ICAP) comprising:
constructing a neighbor list of neighboring indoor cellular access points (NICAPs);
detecting at least one overlay macro base stations (OMBSs);
associating the overlay macro base stations with the indoor cellular access point; and
transmitting a message to a mobile station (MS) wherein the message includes the neighbor list.

2. The method of claim 1 wherein constructing includes:
generating an operator identifier (OID) from a base station ID (BSID) of the ICAP; and
adding, to the neighbor list, only neighboring ICAPs that include an substantially equivalent OID to the OID of the ICAP.

3. The method if claim 1 wherein constructing includes:
having a page group identifier (PGID) associated with the ICAP; and
adding to the neighbor list, only neighboring ICAPs and MBSs that include a substantially equivalent PGID to the PGID of the ICAP.

4. The method of claim 2 wherein constructing includes:
scanning for neighboring ICAPs (NICAPs) within range of the ICAP;
deriving an OID for each NICAP from a BSID associated with the NICAP;
determining if the OID of the NICAP is substantially equivalent to the OID of the ICAP; and
if so, adding the NICAP to the neighbor list.

5. The method of claim 1 wherein constructing includes:
receiving a list of NICAPs from a gateway server.

6. The method of claim 5 further including:
improving the neighbor list based upon message(s) received from at least one MS;
reporting at least a portion of the improved neighbor list to the gateway.

7. The method of claim 1 wherein constructing includes:
scanning for neighboring ICAPs (NICAPs) within range of the ICAP;
requesting that a gateway determine if a scanned NICAP is within a same network as the ICAP;
receiving a confirmation message indicating whether or not the scanned NICAP is within the same network as the ICAP; and
if the scanned NICAP is within the same network, adding the scanned NICAP to the neighboring list.

8. The method of claim 1 wherein constructing includes:
using a physical location of the ICAP to determine the neighboring ICAPs (NICAPs).

9. The method of claim 1 wherein transmitting includes, if the ICAP is topologically on the edge of a network to which the ICAP belongs, transmitting a list of the OMBSs to the MS.

10. A method of using a mobile station (MS) with an indoor cellular access point (ICAP) comprising:
authorizing the MS to join a network including the ICAP, wherein the network includes a range;
receiving a message including information regarding a set of neighboring ICAPs (NICAPs);
updating a neighbor list using at least part of the information of the received message;
if the MS leaves the range of the network, updating the neighbor list by removing at least part of the information of the received message; and
if the MS enters the range of the network, updating the neighbor list by adding at least part of the information of the received message.

11. The method of claim 10 wherein authorizing includes using an authorization technique selected from a group consisting of the following:
manually registering via the MS,
authenticating via a web site, and
using a preconfigured profile stored on the MS.

12. The method of claim 10 wherein receiving includes receiving a message that includes an operator identifier (OID); and
updating includes using the OID as a mask to identify ICAPs belonging within the network.

13. The method of claim 10 wherein receiving includes receiving a message that includes a list of base station identifiers (BSIDs) for a plurality of ICAPs.

14. The method of claim 10 further including:
receiving a message that includes a mapping of at least one NICAP to at least one overlay macro bases station (OMBS);
determining if a detected macro base station (MBS) is an OMBS; and
if so, adding the NICAPs associated with the OMBS to the MS's neighbor list.

15. The method of claim 10 further including:
maintaining an associative list between macro base stations (MBSs) and ICAPs; and
searching for an ICAP only when the MS is within range of a MBS that is associated with at least one ICAP.

16. The method of claim 10 further including:
storing at least one piece of information associated with the ICAP, wherein the stored information is selected from a group consisting of a carrier frequency, a preamble identifier of a base station, or a physical location; and
using the stored information to reduce power usage by the MS; and
using the stored information to improve a base station search technique used by the MS to find a base station.

17. An indoor cellular access point (ICAP) comprising:
a wireless transceiver configured to:
detect at least one overlay macro base stations (OMBSs), and
transmit a message to a mobile station (MS) wherein the message includes a neighbor list and a list of associated OMBSs;
a controller configured to:
construct the neighbor list, wherein the list includes an identification of neighboring indoor cellular access points (NICAPs); and
a memory configured to:
associate the OMBSs with the ICAP.

18. The ICAP of claim 17 wherein the controller is configured to:
generate an operator identifier (OID) from a base station ID (BSID) of the ICAP; and
add, to the neighbor list, only neighboring ICAPs that include an substantially equivalent OID to the OID of the ICAP.

19. The ICAP of claim 18 wherein the wireless transceiver is configured to:
scan for neighboring ICAPs (NICAPs) within range of the ICAP; and wherein the controller is configured to:
derive a OID for each ICAP from a BSID associated with the NICAP,
determine if the OID of the NICAP is substantially equivalent to the OID of the ICAP, and
if so, add the NICAP to the neighbor list.

20. A mobile station (MS) capable of interacting with a indoor cellular access point (ICAP) comprising:
a wireless transceiver configured to:
establish the MS on a network including the ICAP, wherein the network includes a range, and
receive a message including information regarding a set of neighboring ICAPs (NICAPs) and associated OMBSs;
a controller configured to:
update a neighbor list using at least part of the information of the received message,
if the MS leaves the range of the network, update the neighbor list by removing at least part of the information of the received message, and
if the MS enters the range of the network, update the neighbor list by adding at least part of the information of the received message; and
a memory configured to:
store a neighbor list.
